(19) United States
(12) Patent Application Publication
(10) Pub. No.: US 2026/0316753 A1
(43) Pub. Date: Oct. 15, 2026

(54) DRIVER ASSISTANCE DEVICE FOR A VEHICLE, METHOD AND CONTROL DEVICE FOR OPERATING A DRIVER ASSISTANCE DEVICE AND VEHICLE

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 19/563,099

(22) Filed: Mar. 11, 2026

(30) Foreign Application Priority Data
Mar. 25, 2025 (DE) 10 2025 111 539.7

(51) Int. Cl. B60W 30/16

(52) U.S. Cl. CPC B60W 30/16; B60W 2300/36; B60W 2300/44; B60W 2552/05; B60W 2554/802; B60W 2710/18

(57) ABSTRACT

A driver assistance device for a vehicle. The driver assistance device includes a read-in interface, a monitoring apparatus, and a control apparatus. The read-in interface is designed to read in a distance signal that represents a distance of the vehicle from another vehicle. The monitoring apparatus is designed to monitor, using the distance signal, whether the read-in distance is exceeded and to output a monitoring signal if the read-in distance is less than a predefined minimum distance. The control apparatus is designed to output a control signal to the driver assistance device in response to the monitoring signal in order to enforce compliance with the predefined minimum distance, wherein compliance with the predefined minimum distance cannot be deactivated.

### FIELD

The present disclosure is based on a driver assistance device for a vehicle, a method and a control device for operating a driver assistance device, and a vehicle. The present disclosure also relates to a computer program.

### BACKGROUND INFORMATION

Vehicles have driver assistance devices that can perform various driver assistance functions.

### SUMMARY

The present disclosure provides a driver assistance device for a vehicle, a method for operating a driver assistance device, a control device that uses this method, a vehicle, and a corresponding computer program. Advantageous developments and improvements of the device are made possible by the measures disclosed herein.

Advantages achievable with the approach presented here include in particular that a driver assistance device can be provided that can perform an advantageous driver assistance function.

According to an example embodiment, a driver assistance device for a vehicle is provided. The driver assistance device has a read-in interface, a monitoring apparatus, and a control apparatus. The read-in interface is designed to read in a distance signal that represents the distance of the vehicle from another vehicle. The monitoring apparatus is designed to monitor, using the distance signal, whether the read-in distance is exceeded and to output a monitoring signal if the read-in distance is less than a predefined minimum distance. The control apparatus is designed to output a control signal to the driver assistance device in response to the monitoring signal in order to enforce compliance with the predefined minimum distance, wherein compliance with the predefined minimum distance cannot be deactivated.

The driver assistance device can be a driver assistance system, or ADAS for short. When the vehicle is ready for operation, the driver assistance device can be activated so that the predefined minimum distance is always maintained, regardless of how closely the driver follows the vehicle ahead. The vehicle may be a rental vehicle and/or a pool vehicle, i.e., a vehicle that is not owned by the driver or any of the vehicle occupants. For example, the driver may be more careless with a rental vehicle and/or willing to take more risks because he is not the owner of the rental vehicle. The approach presented here can prevent this carelessness and/or risk-taking by the driver, thereby protecting the driver, other occupants and other road users, and reducing the risk of damage and injury. The approach presented here activates a so-called ADC/RDA forced mode for the vehicle, whereby the driver can operate the vehicle in the manner desired, but the distance, which can also be referred to as the safety distance, can always be enforced.

The monitoring apparatus and/or the control apparatus cannot be deactivated by the driver and/or a vehicle occupant when the vehicle is driving off-road. Off-road driving can involve, for example, an off-road route such as a gravel road, a desert trail, a snow-covered road, or a similar unpaved route. For example, a number of vehicles may be engaged in off-road driving, where these vehicles may be designed as snowmobiles, quads, or similar off-road vehicles. The vehicles can drive in a convoy, wherein, for example, the vehicle can always maintain a distance from a vehicle in front, which can increase safety for the driver and/or a vehicle occupant and the other drivers in the convoy.

The monitoring apparatus and/or the control apparatus can be capable of being overridden by the driver and/or a vehicle occupant when the vehicle is in road travel. The road travel may be a trip in public road traffic. Advantageously, the driver and/or the vehicle occupant can override the maintaining of the predefined distance if, for example, an overtaking maneuver is necessary for safety reasons and the predefined distance cannot be maintained while executing it.

The control apparatus can be designed to output the control signal to the driver assistance device in response to the monitoring signal in order to control a brake unit as the driver assistance function of the vehicle in order to enforce compliance with the minimum distance.

The control apparatus can be designed to output a control signal to the driver assistance device in response to the monitoring signal, in order to prevent or abort an overtaking maneuver by the vehicle as the driver assistance function of the vehicle, in order to enforce the maintaining of the minimum distance. In other words, the driver assistance function can be enforced with an additional vehicle width. The driver can drive the vehicle as he would like, but the distance can always be maintained and overtaking maneuvers can be prevented. This driver assistance function, i.e., preventing or aborting the overtaking maneuver, cannot be deactivated when the vehicle is driving off-road. On the off-road path, the vehicles may drive in a convoy through rough terrain. Overtaking here can be dangerous, so the overtaking maneuver may be prevented and/or aborted. If the vehicles are in road travel, i.e. driving in public road traffic, the prevention or abortion of the overtaking maneuver can be overridden, for example by the driver and/or the vehicle occupant. This can be advantageous if, for example, an overtaking maneuver is necessary for safety reasons.

A method for operating an embodiment of a driver assistance device mentioned herein comprises a reading-in step, a providing step, and an outputting step. In the reading-in step, a distance signal is read in that represents the distance of the vehicle from another vehicle. In the providing step, a monitoring signal is provided, using the distance signal, wherein the monitoring signal represents monitoring for the exceeding of the read-in distance. The monitoring signal is output when the read-in distance is less than a predefined minimum distance. In the outputting step, a control signal is output in response to the monitoring signal. The control signal is output to the driver assistance device in order to enforce compliance with the predefined minimum distance.

This method can be implemented, for example, in software or hardware or in a mixed form of software and hardware, for example in a control appliance.

The approach presented here further provides a control device which is designed to carry out, control or implement the steps of a variant of a method presented here in corresponding apparatuses. The object of the present disclosure can also be achieved quickly and efficiently by this embodiment variant of the present disclosure in the form of a control device.

For this purpose, the control device can comprise at least one computing unit for processing signals or data, at least one memory unit for storing signals or data, at least one interface to a sensor or an actuator for reading in sensor signals from the sensor or for outputting data signals or control signals to the actuator and/or at least one communication interface for reading in or outputting data that are embedded in a communication protocol. The computing unit can, for example, be a signal processor, a microcontroller or the like, and the memory unit can be a flash memory or a magnetic memory unit. The communication interface can be designed to read in or output data wirelessly and/or in a wired form, a communication interface, which can read in or output wired data, being able to read in these data, for example electrically or optically, from a corresponding data transmission line, or being able to output these data into a corresponding data transmission line.

In the present case, a control device can be understood to be an electrical appliance that processes sensor signals and, on the basis of these signals, outputs control signals and/or data signals. The control device can have an interface that can be designed as hardware and/or software. In a hardware embodiment, the interfaces can, for example, be part of a so-called system ASIC, which contains a wide variety of functions of the control device. However, it is also possible for the interfaces to be separate integrated circuits or at least partially consist of discrete components. In the case of a software embodiment being used, the interfaces can be software modules that are present, for example, on a microcontroller in addition to other software modules.

A vehicle comprises one embodiment of a driver assistance device named herein. The vehicle can be for example a rental vehicle, such as cars, golf carts, motorcycles, snowmobiles, personal watercraft, quad bikes, side-by-side vehicles, etc. The vehicle can be rented, for example, for off-road driving, wherein the vehicle can always maintain the predefined minimum distance. This driver assistance device cannot be deactivated when the vehicle is driving off-road. An overtaking maneuver by the vehicle can also be aborted and/or prevented when the vehicle is driving off-road. If the vehicle is in road travel, the maintaining of the predefined minimum distance, and/or aborting and/or preventing the overtaking maneuver, can be overridden for safety reasons.

The vehicle can be designed as a two-wheeled and/or single-track vehicle. For example, the vehicle can be designed as a motorcycle. Especially in such an embodiment of the approach presented here, the aforementioned advantages with regard to driving safety are particularly evident.

A computer program product or a computer program, which has program code that can be stored on a machine-readable carrier or storage medium, such as a semiconductor memory, a hard disk memory, or an optical memory, and that is used for carrying out, implementing, and/or controlling the steps of the method according to one of the embodiments described above, in particular when the program product or program is executed on a computer or a device, is advantageous as well.

Exemplary embodiments of the approach presented here are illustrated in the figures and explained in more detail in the following description.

### BRIEF DESCRIPTION OF THE DRAWINGS

FIG. 1 is a schematic representation of an exemplary embodiment of a vehicle.

FIG. 2 is a flow chart of an exemplary embodiment of a method for operating a driver assistance device.

FIG. 3 is a block diagram of an exemplary embodiment of a control device for operating a driver assistance device.

### DETAILED DESCRIPTION OF EXAMPLE EMBODIMENTS

In the following description of advantageous exemplary embodiments of the present disclosure, the same or similar reference signs are used for the elements shown in the various figures and acting similarly, as a result of which a repeated description of these elements is omitted.

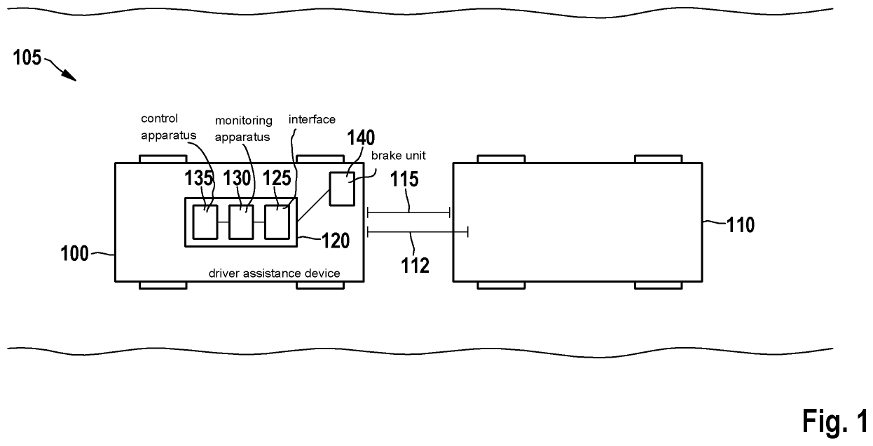

FIG. 1 is a schematic representation of an exemplary embodiment of a vehicle 100. The vehicle 100 is for example a rental vehicle, wherein the vehicle 100 is optionally designed as a two-wheeled vehicle, even though the vehicle is shown as a passenger car in the illustration according to FIG. 1.

For example, the vehicle 100 is driving off-road, i.e. on an off-road route 105. Another vehicle 110 is driving in front of the vehicle 100 and is also shown in off-road driving. The vehicle 100 is designed to maintain a predefined minimum distance 112 (which may also depend on at least one other driving parameter, such as current driving speed) from the other vehicle 110. In the scenario shown in FIG. 1, the vehicle 100 exceeds the predefined minimum distance 112, wherein the vehicle 100 has a distance 115 from the other vehicle 110 that is smaller than the predefined minimum distance 112.

The vehicle 100 has a driver assistance device 120, wherein the driver assistance device 120 has a read-in interface 125, a monitoring apparatus 130 and a control apparatus 135. The read-in interface 125 is designed to read in a distance signal. The distance signal represents the distance 115 of the vehicle 100 from the other vehicle 110.

The monitoring apparatus 130 is designed to monitor, using the distance signal, whether the read-in distance 115 is exceeded. The monitoring apparatus 130 is additionally designed to output the monitoring signal when the read-in distance 115 is smaller than the predefined minimum distance 112. In other words, the monitoring signal is output if the driver of the vehicle 100 does not maintain the predefined minimum distance 112.

The control apparatus 135 is designed to output a control signal to the driver assistance device 120 in response to the monitoring signal. The control signal is output to enforce maintenance of the predefined minimum distance 112. In other words, the driver of the vehicle 100 is prevented from exceeding the predefined minimum distance 112. According to one exemplary embodiment, the monitoring apparatus 130 and/or the control apparatus 135 cannot be deactivated by the driver and/or a vehicle occupant; therefore, the driver and/or vehicle occupant cannot unlock these driver assistance functions. This applies for example when the vehicles 100 and 110 are driving off-road, as shown in FIG. 1. Off-road driving refers, for example, to an off-road route 105 such as a gravel road, a desert trail, a snow trail, or a similar unpaved route. According to one exemplary embodiment, a plurality of vehicles 100, 110 are on the off-road track 105, wherein the vehicles 100, 110 are designed as snowmobiles, quads, or similar off-road vehicles. The vehicles 100 and 110, for example, are traveling in a convoy, wherein the vehicle 100 always maintains a distance from the vehicle 110 in front, which increases safety for the driver and/or a vehicle occupant and the other drivers in the convoy. The maintaining of the predefined minimum distance 112 therefore cannot be deactivated when the vehicle 100 is driving off-road.

According to one exemplary embodiment, the control signal is output to the driver assistance device 120 to control a brake unit 140 in order to maintain the minimum distance 112. If for example the driver of the vehicle 100 exceeds the minimum distance 112, the vehicle 100 automatically brakes, for example until the predefined minimum distance 112 from the other vehicle 110 is reached again.

According to another exemplary embodiment, the control signal is output to the driver assistance device 120 in order to prevent and/or abort an overtaking maneuver of the vehicle 100 in order to maintain the minimum distance 112. For example, if the driver of the vehicle 100 begins an overtaking maneuver to overtake the other vehicle 110, this maneuver is prevented and/or aborted by the driver assistance device 120. This driver assistance function engages and cannot be deactivated when the vehicle 100 is driving off-road. On the off-road route 105, the vehicles 100 and 110 are driving in a convoy through rough terrain. Overtaking can be dangerous here, so the overtaking maneuver is prevented and/or aborted. When the vehicles 100 and 110 are in road travel, i.e. driving in public road traffic, this driver assistance function can be overridden by the driver and/or the vehicle occupants, for example. This is advantageous if, for example, an overtaking operation is necessary for safety reasons and the predefined distance cannot be maintained while performing it.

The approach presented here is briefly summarized as follows: one problem with rental agencies and pool management is the lack of respect shown by users for the rented vehicle and the prescribed rules. The user, in this case the driver, is more careless and/or reckless with a rental vehicle than with their own vehicle. For example, it is difficult for the user to follow the rules when renting a vehicle for a safari tour, i.e. maintaining a safe distance, not overtaking, etc.

This leads for example to a higher risk for people, vehicles and/or infrastructure, but also to additional costs for the rental agency/pool agency due to repairs and/or insurance premiums. If such a vehicle is equipped with a regular driver assistance device, the user always has the option of deactivating it. The approach presented here prevents this by providing the driver assistance device 120 with a so-called lock mode for the driver. The driver can drive the vehicle 100 in the manner desired, but the distance 112 will always be enforced. Additionally or alternatively, the driver can drive the vehicle 100 in the manner desired, but overtaking maneuvers are prevented. This so-called lock mode cannot be unlocked by the driver, meaning the distance is always maintained and/or the overtaking maneuver is always prevented or aborted.

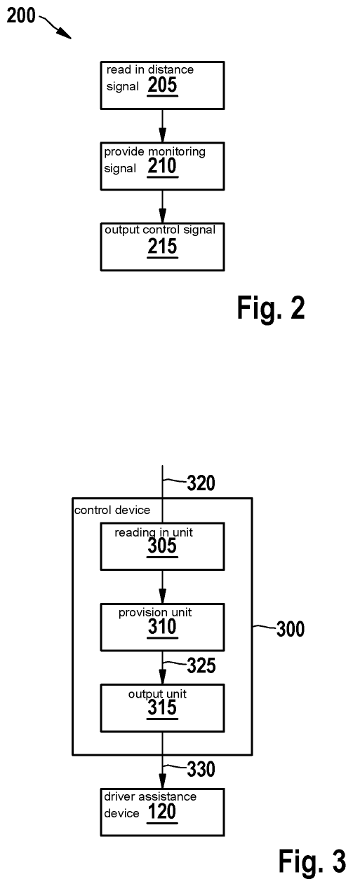

FIG. 2 is a flowchart of an exemplary embodiment of a method 200 for operating a driver assistance device. The driver assistance device is the driver assistance device shown in FIG. 1, or a similar driver assistance device.

The method 200 comprises a reading-in step 205, a providing step 210 and an outputting step 215. In the reading-in step 205, a distance signal is read in that represents the distance of the vehicle from another vehicle. In the providing step 210, a monitoring signal is provided, using the distance signal, wherein the monitoring signal represents monitoring for an exceeding of the read-in distance. The monitoring signal is output when the read-in distance is less than a predefined minimum distance. In the outputting step 215, a control signal is output in response to the monitoring signal. The control signal is output to the driver assistance device in order to enforce compliance with the predefined minimum distance.

FIG. 3 is a block diagram of an exemplary embodiment of a control device 300 for operating a driver assistance device. The control device 300 is designed to control and/or carry out the method from FIG. 2 or a similar method.

For this purpose, the control device 300 has a unit 305 for reading in, a unit 310 for providing, and a unit 315 for outputting. The unit 305 for reading in is designed to read in a distance signal 320, where the distance signal 120 represents a distance of one vehicle from another vehicle.

The unit 310 for providing is designed to provide a monitoring signal 325, using the distance signal 320. The monitoring signal 325 represents monitoring for an exceeding of a read-in distance. The monitoring signal 320 is output when the read-in distance is less than a predefined minimum distance.

The unit 115 for outputting is designed to output a control signal 330 in response to the monitoring signal 325. The control signal 330 is output to the driver assistance device 120 in order to enforce compliance with the predefined minimum distance.

If an exemplary embodiment has an “and/or” link between a first feature and a second feature, this is to be understood to mean that the exemplary embodiment according to one example has both the first feature and the second feature and, according to a further exemplary example, either only the first feature or only the second feature.

1-11. (canceled)

12. A driver assistance device for a vehicle, wherein the driver assistance device comprises:
a read-in interface configured to read in a distance signal that represents a distance of the vehicle from another vehicle;
a monitoring apparatus configured to monitor, using the distance signal, an exceeding of the distance of the vehicle from the another vehicle, and to output a monitoring signal if the distance of the vehicle from the another vehicle is less than a predefined minimum distance; and
a control apparatus configured to output a control signal to the driver assistance device in response to the monitoring signal to enforce compliance with the predefined minimum distance, wherein the compliance with the predefined minimum distance cannot be deactivated.

13. The driver assistance device according to claim 12, wherein the monitoring apparatus and/or the control apparatus cannot be deactivated by a driver and/or a vehicle occupant when the vehicle is driving off-road.

14. The driver assistance device according to claim 12, wherein the monitoring apparatus and/or the control apparatus can be overridden by a driver and/or a vehicle occupant when the vehicle is in road travel.

15. The driver assistance device according to claim 12, wherein the control apparatus is designed to output the control signal to the driver assistance device in response to the monitoring signal to control a brake unit as a driver assistance function of the vehicle to enforce the compliance with the predefined minimum distance.

16. The driver assistance device according to claim 12, wherein the control apparatus is configured to output the control signal to the driver assistance device in response to the monitoring signal to prevent and/or abort an overtaking maneuver of the vehicle as a driver assistance function of the vehicle to enforce the compliance with the predefined minimum distance.

17. A method for operating a driver assistance device of a vehicle, the method comprising the following steps:
reading in a distance signal that represents a distance of the vehicle from another vehicle;
providing a monitoring signal, using the distance signal, wherein the monitoring signal represents monitoring of an exceeding of the distance of the vehicle from the another vehicle and is output when the distance of the vehicle from the another vehicle is less than a predefined minimum distance; and
outputting a control signal, in response to the monitoring signal, wherein the control signal is output to the driver assistance device to enforce compliance with the predefined minimum distance.

18. A control device configured to operate a driver assistance device of a vehicle, the control device configured to perform the following steps:
reading in a distance signal that represents a distance of the vehicle from another vehicle;
providing a monitoring signal, using the distance signal, wherein the monitoring signal represents monitoring of an exceeding of the distance of the vehicle from the another vehicle and is output when the distance of the vehicle from the another vehicle is less than a predefined minimum distance; and
outputting a control signal, in response to the monitoring signal, wherein the control signal is output to the driver assistance device to enforce compliance with the predefined minimum distance.

19. A vehicle, comprising:
a driver assistance device, wherein the driver assistance device includes:
a read-in interface configured to read in a distance signal that represents a distance of the vehicle from another vehicle,
a monitoring apparatus configured to monitor, using the distance signal, an exceeding of the distance of the vehicle from the another vehicle, and to output a monitoring signal if the distance of the vehicle from the another vehicle is less than a predefined minimum distance, and
a control apparatus configured to output a control signal to the driver assistance device in response to the monitoring signal to enforce compliance with the predefined minimum distance, wherein the compliance with the predefined minimum distance cannot be deactivated.

20. The vehicle according to claim 19, wherein the vehicle is a two-wheeled and/or single-track vehicle.

21. A non-transitory machine-readable storage medium on which is stored a computer program for operating a driver assistance device of a vehicle, the computer program, when executed by a computer, causing the computer to perform the following steps:
reading in a distance signal that represents a distance of the vehicle from another vehicle;
providing a monitoring signal, using the distance signal, wherein the monitoring signal represents monitoring an exceeding of the distance of the vehicle from the another vehicle and is output when the distance of the vehicle from the another vehicle is less than a predefined minimum distance; and
outputting a control signal, in response to the monitoring signal, wherein the control signal is output to the driver assistance device to enforce compliance with the predefined minimum distance.
